(19) United States
(12) Patent Application Publication
(10) Pub. No.: US 2008/0147823 A1
(43) Pub. Date: Jun. 19, 2008

(54) Structured data receiving apparatus, receiving method, reviving program, transmitting apparatus, and transmitting method

(75) Inventor: Tomohiro Azami, Yokosuka-shi (JP)

Correspondence Address: Gary M. Nath;THE NATH LAW GROUP, 112 South West Street, Alexandria, VA, 22314, US

(73) Assignee: VICTOR COMPANY OF JAPAN, LIMITED

(21) Appl. No.: 12/010,031

(22) Filed: Jan. 18, 2008

Related U.S. Application Data
(63) Continuation of application No. 10/668,301, filed on Sep. 24, 2003.

(30) Foreign Application Priority Data
Sep. 26, 2002 (JP) P2002-280537
Feb. 28, 2003 (JP) P2003-052759
Mar. 26, 2003 (JP) P2003-083986

(51) Int. Cl. G06F 15/16

(52) U.S. Cl. 709/217

(57) ABSTRACT

A plurality of fragment data and a plurality of fragment configuration information, created one for each fragment data, to concatenate the plurality of fragment data in a receiving side to generate structured data having a tree structure are received. Each piece of fragment configuration information includes reference information having identification information identifying corresponding fragment data from the plurality of fragment data and position information on the connection position of the corresponding fragment data in the generated structured data. The received fragment data is concatenated to generate structured data based on the position information and the reference information included in the received fragment configuration information.

### BACKGROUND OF THE INVENTION

1. Field of the Invention

The present invention relates to a receiving apparatus, a receiving method, and a receiving program for receiving structured data such as structured metadata describing the detail of multimedia content, and to a transmitting apparatus and a transmitting method for transmitting the structured data.

2. Description of the Related Art

MPEG-7 (ISO/IEC 15938) is defined as a standard for the framework describing the detail of multimedia content. MPEG-7 is a standard for structured metadata that temporally and spatially structures multimedia content and describes the detail of the multimedia content in a tree structure format.

MPEG-7 metadata, characterized in that it is structured as a tree structure, is described in the text format using XML (Extensible Markup Language). The format of XML elements and attributes of MPEG-7 metadata is defined using XML schemas.

The MPEG-7 standard is composed of a plurality of parts. Part 1, the MPEG-7 system ((standard number: ISO/IEC 15938-1:2002, title: Information technology—Multimedia content description interface—Part 1: Systems, available at: ISO (http://www.iso.ch/) or Japanese Standards Association (http:/www.jsa.or.jp/)), defines the framework of metadata transmission and accumulation, metadata compression method, and so on.

In the MPEG-7 system, MPEG-7 metadata is fragmented before being transmitted. The receiving side serially concatenates received metadata fragments to dynamically generate MPEG-7 metadata.

FIG. 1 is a conceptual diagram showing the structure of a MPEG-7 description stream in the MPEG-7 system. The MPEG-7 description stream is composed of the decoder initial configuration (DecorderInit) followed by a plurality of access units (Access Unit: AU). The decoder initial configuration contains the various initial settings for running the receiver side decoder. An access unit, the minimum-processing unit to be processed per unit time, is composed of a plurality of fragment update units (Fragment Update Unit: FUU). A fragment update unit, a unit for transmitting metadata fragments, is composed of a fragment update command (FU Command), a fragment update context (FU Context), and a fragment update payload (FU Payload). The fragment update command is a command indicating a fragment processing method. There are four types of command: “add”, “replace”, “delete”, and “reset”. The fragment update context is path information indicating a node to which the command is to be applied in a metadata tree generated in the receiving side. The fragment update payload stores a metadata fragment.

Dynamic generation of metadata using fragment update units will be described below more in detail. FIG. 2 is a conceptual diagram showing how the “add” command in the fragment update unit adds a fragment to a metadata tree. The metadata tree generated in the receiving side is shown in the right half of the figure. Assume that the part of the tree drawn by solid lines has been generated in the initial stage (the part drawn by dotted lines has not yet generated). Next, the fragment update unit in the left half of the figure is processed. The fragment update command included in this fragment update unit is an “add” command. The fragment update context specifies a node in the metadata tree generated in the receiver side, and the fragment update payload stores a fragment of metadata. When this fragment update unit is processed, the fragment stored in the fragment update payload is added to the node specified by the fragment update context. That is, the dotted part in the right half of the figure is generated.

The transmitting side can also dynamically update the metadata tree, generated in the receiver side, not only by the “add” command but also by the “replace”, “delete”, or reset” command.

Because the framework of MPEG-7 metadata transmission in the MPEG-7 system described above is designed to transmit XML data whose format is defined by XML schemas, not only MPEG-7 metadata but also any XML data whose format is defined by XML schemas, that is, structured data, can be transmitted.

The MPEG-7 metadata transmission method in the MPEG-7 system described above allows the transmitting side to fragment and transmit MPEG-7 metadata to dynamically generate or update MPEG-7 metadata in the receiving side. The transmitting side can transmit not only MPEG-7 metadata but also any XML data whose format is defined by XML schemas, that is, structured data. However, the problem with this method is that the receiving side can neither actively acquire or concatenate a part or all of the fragments of structured data as necessary nor determine the time at which fragments are to be acquired or concatenated.

### SUMMARY OF THE INVENTION

In view of the foregoing, it is an object of the present invention to provide a receiving apparatus, a receiving method, a reviving program, a transmitting apparatus, and a transmitting method, for use in a system where structured data is fragmented for transmission and reception, that not only allow the transmitting side to dynamically generate and update structured data in the receiving side but also allow the receiving side to actively acquire and concatenate a part of all of structured data as necessary and, in addition, to determine the time at which the receiving side acquires or concatenates the fragments.

To achieve the above objects, there is provided a structured data receiving apparatus receiving a plurality of fragment data and a plurality of fragment configuration information, created one for each fragment data, to concatenate the plurality of fragment data into structured data stored in a receiving side and having a tree structure, each piece of fragment configuration information including reference information having identification information identifying corresponding fragment data from the plurality of fragment data and position information on a connection position of the corresponding fragment data in the structured data, the structured data receiving apparatus comprising: receiving means for receiving the fragment data and the fragment configuration information and outputting them; fragment data storing means for storing the fragment data output from the receiving means; structured data storing means for storing the structured data; and structured data concatenating means for concatenating predetermined fragment data, read from the fragment data storing means, into the structured data read from the structured data storing means, based on the position information and the reference information included in the fragment configuration information output from the receiving means.

To achieve the above objects, there is provided a structured data receiving apparatus receiving a plurality of fragment data and a plurality of fragment configuration information, created one for each fragment data, to concatenate the plurality of fragment data into structured data stored in a receiving side and having a tree structure, each piece of fragment configuration information including reference information having location information on a location of corresponding fragment data and position information on a connection position of the corresponding fragment data in the structured data, the structured data receiving apparatus comprising: fragment configuration information receiving means for receiving the fragment configuration information and outputting it; fragment data receiving means for identifying the location of the fragment data, based on the reference information included in the fragment configuration information output from the fragment configuration information receiving means, and for receiving the fragment data from the identified location and outputting it; structured data storing means for storing the structured data; and structured data concatenating means for concatenating the fragment data, acquired by the fragment data receiving means, into the structured data read from the structured data storing means, based on the position information included in the fragment configuration information output from the fragment configuration information receiving means.

In a preferred embodiment of the present invention, the position information is position information having information specifying a node in the structured data and information specifying a connection position of the corresponding fragment data in relation to the specified node.

In a preferred embodiment of the present invention, the information specifying the connection position of the corresponding fragment data in relation to the specified node is either information specifying a position, which is at the same level as that of the specified node in relation to a node that is one level higher than that of the specified node and which immediately precedes the specified node, as the connection position of a highest node of the corresponding fragment data, or information specifying a position, which is a position at one level lower than that of the specified node and which is the last node at the lower level, as the connection position of the highest node of the corresponding fragment data.

In a preferred embodiment of the present invention, the reference information has information on contents of the corresponding fragment data and the structured data concatenating means concatenates the fragment data into the structured data, the fragment data being determined to be concatenated based on the information on the contents.

In a preferred embodiment of the present invention, the reference information includes information on a name of a highest node of the corresponding fragment data and the structured data concatenating means processes the position information based on the information on the name of the highest node.

In a preferred embodiment of the present invention, the fragment configuration information has information on a method for processing the fragment data; for a part of the fragment data, fragment update data is received instead of the fragment configuration information corresponding to the fragment data, the fragment update data being created by adding the information on the fragment data processing method and the position information on a connection position in the structured data to the fragment data; the receiving means receives the fragment data, the fragment configuration information, and the fragment update data and outputs them and; based on the information on the processing method included in the fragment update data output from the receiving means, the structured data concatenating means also has a function that concatenates the fragment data, included in the fragment update data, into the structured data.

To achieve the above objects, there is provided a structured data receiving method of receiving a plurality of fragment data and a plurality of fragment configuration information, created one for each fragment data, to concatenate the plurality of fragment data in a receiving side to generate structured data having a tree structure, each piece of fragment configuration information including reference information having identification information identifying corresponding fragment data from the plurality of fragment data and position information on a connection position of the corresponding fragment data in the generated structured data, the structured data receiving method comprising the step of concatenating the received fragment data to generate the structured data, based on the position information and the reference information included in the received fragment configuration information.

To achieve the above objects, there is provided a structured data receiving method of receiving a plurality of fragment data and a plurality of fragment configuration information, created one for each fragment data, to concatenate the plurality of fragment data in a receiving side to generate structured data stored having a tree structure, each piece of fragment configuration information including reference information having location information on a location of corresponding fragment data and position information on a connection position of the corresponding fragment data in the generated structured data, the structured data receiving method comprising the step of concatenating the received fragment data to generate the structured data, based on the position information and the reference information included in the received fragment configuration information.

To achieve the above objects, there is provided a structured data receiving program causing a computer to function as a receiving apparatus receiving a plurality of fragment data and a plurality of fragment configuration information, created one for each fragment data, to concatenate the plurality of fragment data into structured data stored in a receiving side and having a tree structure, each piece of fragment configuration information including reference information having identification information identifying corresponding fragment data from the plurality of fragment data and position information on a connection position of the corresponding fragment data in the structured data, the structured data receiving program comprising: a receiving function for receiving the fragment data and the fragment configuration information and outputting them; and a structured data concatenating function for concatenating the received fragment data into the structured data based on the position information and the reference information included in the received fragment configuration information.

To achieve the above objects, there is provided a structured data receiving program causing a computer to function as a receiving apparatus receiving a plurality of fragment data and a plurality of fragment configuration information, created one for each fragment data, to concatenate the plurality of fragment data into structured data stored in a receiving side and having a tree structure, each piece of fragment configuration information including reference information having location information on a location of corresponding fragment data and position information on a connection position of the corresponding fragment data in the structured data, the structured data receiving program comprising: a fragment configuration information receiving function for receiving the fragment configuration information and outputting it; a fragment data receiving function for identifying the location of the fragment data, based on the reference information included in the received fragment configuration information and for receiving the fragment data from the identified location and outputting it; and a structured data concatenating function for concatenating the received fragment data into the structured data, based on the position information included in the received fragment configuration information.

To achieve the above objects, there is provided a structured data transmitting apparatus transmitting a plurality of fragment data and a plurality of fragment configuration information, created one for each fragment data, to concatenate the plurality of fragment data in a receiving side to generate structured data having a tree structure, each piece of fragment configuration information including reference information having identification information identifying corresponding fragment data from the plurality of fragment data and position information on a connection position of the corresponding fragment data in the generated structured data, the structured data transmitting apparatus comprising: transmitting means for transmitting a data stream generated by arranging the fragment data and the fragment configuration information one after another.

To achieve the above objects, there is provided a structured data transmitting apparatus transmitting a plurality of fragment data and a plurality of fragment configuration information, created one for each fragment data, to concatenate the plurality of fragment data in a receiving side to generate structured data having a tree structure, each piece of fragment configuration information including reference information having location information on a location of corresponding fragment data and position information on a connection position of the corresponding fragment data in the structured data, the structured data transmitting apparatus comprising: transmitting means that, when any of the fragment data or all the fragment configuration information is requested by the receiving side, transmits the requested fragment data or the requested all the fragment configuration information to the receiving side.

In a preferred embodiment of the present invention,

the position information is position information having information specifying a node in the structured data and information specifying a connection position of the corresponding fragment data in relation to the specified node.

In a preferred embodiment of the present invention, the information specifying a connection position of the corresponding fragment data in relation to the specified node is either information specifying a position, which is at the same level as that of the specified node in relation to a node that is one level higher than that of the specified node and which immediately precedes the specified node, as the connection position of a highest node of the corresponding fragment data, or information specifying a position, which is a position at one level lower than that of the specified node and which is the last node at the lower level, as the connection position of the highest node of the corresponding fragment data.

In a preferred embodiment of the present invention, the reference information has information on contents of the corresponding fragment data.

In a preferred embodiment of the present invention, the reference information includes information on a name of a highest node of the corresponding fragment data.

In a preferred embodiment of the present invention, the fragment configuration information has information on a method for processing the fragment data, the transmitting apparatus further comprises fragment update data generating means for generating, for a part of the fragment data, fragment update data instead of the fragment configuration information corresponding to the fragment data, the fragment update data being created by adding the information on the fragment data processing method and the position information on a connection position in the structured data to the fragment data, and the transmitting means transmits a data stream generated by arranging the fragment data, the fragment configuration information, and the fragment update data, one after another.

To achieve the above objects, there is provided a structured data transmitting method of transmitting a plurality of fragment data and a plurality of fragment configuration information, created one for each fragment data, to concatenate the plurality of fragment data in a receiving side to generate structured data having a tree structure, each piece of fragment configuration information including reference information having identification information identifying corresponding fragment data from the plurality of fragment data and position information on a connection position of the corresponding fragment data in the generated structured data, the structured data transmitting method comprising the step of transmitting a data stream generated by arranging the fragment data and the fragment configuration information, one after another.

To achieve the above objects, there is provided a structured data transmitting method of transmitting a plurality of fragment data and a plurality of fragment configuration information, created one for each fragment data, to concatenate the plurality of fragment data in a receiving side to generate structured data having a tree structure, each piece of fragment configuration information including reference information having location information on a location of corresponding fragment data and position information on a connection position of the corresponding fragment data in the generated structured data, the structured data transmitting method comprising the step of, in response to a request for one of the fragment data or all the fragment configuration information from the receiving side, transmitting the requested fragment data or the requested all the fragment configuration information to the receiving side.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a conceptual diagram showing the structure of an MPEG-7 description stream in the MPEG-7 system;

FIG. 2 is a conceptual diagram showing how a fragment is added to a metadata tree by the “add” command included in a fragment update unit in the MPEG-7 system;

FIG. 3 is a diagram showing the configuration of a content data and metadata transmission system in a first embodiment;

FIG. 4 is a diagram showing the overview of structured data fragmentation processing in the first embodiment;

FIG. 5 is a diagram showing the structure of fragment configuration information in the first embodiment;

FIG. 6 is a diagram showing an example of how to specify position information in the fragment configuration information in the first embodiment;

FIG. 7 is a diagram showing an example of how to specify position information in the fragment configuration information in the first embodiment;

FIG. 8 is a diagram showing an example of how to specify position information in the fragment configuration information in the first embodiment;

FIG. 9 is a diagram showing an example of how to specify position information in the fragment configuration information in the first embodiment;

FIG. 10 is a diagram showing the configuration of a content data and metadata transmitting apparatus in the first embodiment;

FIG. 11 is a diagram showing the configuration of a content data and metadata receiving apparatus in the first embodiment;

FIG. 12 is a diagram showing an example of how the fragment configuration information is processed in the content data and metadata receiving apparatus in the first embodiment;

FIG. 13 is a diagram showing an example of how the fragment configuration information is processed in the content data and metadata receiving apparatus in the first embodiment;

FIG. 14 is a diagram showing an example of how the fragment configuration information is processed in the content data and metadata receiving apparatus in the first embodiment;

FIG. 15 is a diagram showing the configuration of a content data and metadata transmission system in a second embodiment;

FIG. 16 is a diagram showing the structure of fragment configuration information in the second embodiment;

FIG. 17 is a diagram showing the configuration of a content data and metadata receiving apparatus in the second embodiment;

FIG. 18 is a diagram showing the configuration of a content data and metadata transmission system in a third embodiment;

FIG. 19 is a diagram showing the configuration of a content data and metadata receiving apparatus in the third embodiment;

FIG. 20 is a diagram showing configuration of a fragment update unit (2) in a metadata stream in a fourth embodiment;

FIG. 21 is a diagram showing the overview of structured data fragmentation processing and metadata stream creation in the fourth embodiment;

FIG. 22 is a diagram showing how the receiving apparatus in the second embodiment is implemented by a computer:

FIG. 23 is a diagram showing the configuration of a computer implementing the receiving apparatus;

FIG. 24 is a flowchart showing the processing of a structured data receiving program executed in a computer;

FIG. 25 is a diagram showing the overview of structured data fragmentation processing in a sixth embodiment; and

FIG. 26 is a diagram showing the configuration of a content data and metadata receiving apparatus in the sixth embodiment.

### DESCRIPTION OF THE PREFERRED EMBODIMENTS

<Basic Configuration>

In one embodiment of a content data and metadata transmission/reception system according to the present invention, original structured data (for example, MPEG-7 metadata or XML data whose format is defined using XML schemas) is divided into a plurality of fragments or a plurality of fragment data to be concatenated as structured data are created. At the same time, for each fragment data, fragment configuration information is created which includes position information specifying the position of the fragment data in the original structured data (or in the structured data to be generated by concatenating fragments) and reference information specifying the fragment data. The reference information included in this fragment configuration information is reference information on the fragment data that includes at least information on the position of the fragment data. The reference information may also describe information on the contents of fragment data so that a user or an application can process the fragment data based on that information.

<Reception/Concatenation>

In the transmission/reception system described above, fragment data is positioned in the structured data to reconfigure the original structured data, based on the position information specifying the position of fragment data in the original structure data (or in the structured data to be generated by concatenating fragments) and the reference information specifying the fragment data included in the fragment configuration information.

### First Embodiment

### Reference Only, Broadcasting

<System Configuration>

FIG. 3 is a diagram showing the configuration of a first embodiment of a content data and metadata transmission/reception system according to the present invention. In this embodiment, a transmitter (TV station) 1 transmits content data (program) and a metadata stream including structured metadata (structured data) about the content data, and a receiver (audience) 3 receives them.

The transmitter 1 creates content data and metadata about the content data. The content data is transmitted to the receiver 3 via broadcasting. The metadata is divided into a plurality of fragment data and, at the same time, fragment configuration information corresponding to each fragment data is created. The fragment data and the fragment configuration information are arranged, one after another, to create a metadata stream, and the created metadata stream is transmitted to the receiver 3 via broadcasting. The receiver 3 receives the content data and the metadata stream via broadcasting, extracts fragment data and fragment configuration information from the metadata stream, and reconfigures the metadata from the fragment data and the fragment configuration information. The reconfigured metadata is used for searching for content data or for viewing.

<Description of Metadata (XML)>

Metadata used in this embodiment, which is structured metadata (structured data) such as MPEG-7 metadata, is described in the text format using XML. The format of XML elements and attributes in the metadata is defined by the XML schemas.

<Fragmentation Processing>

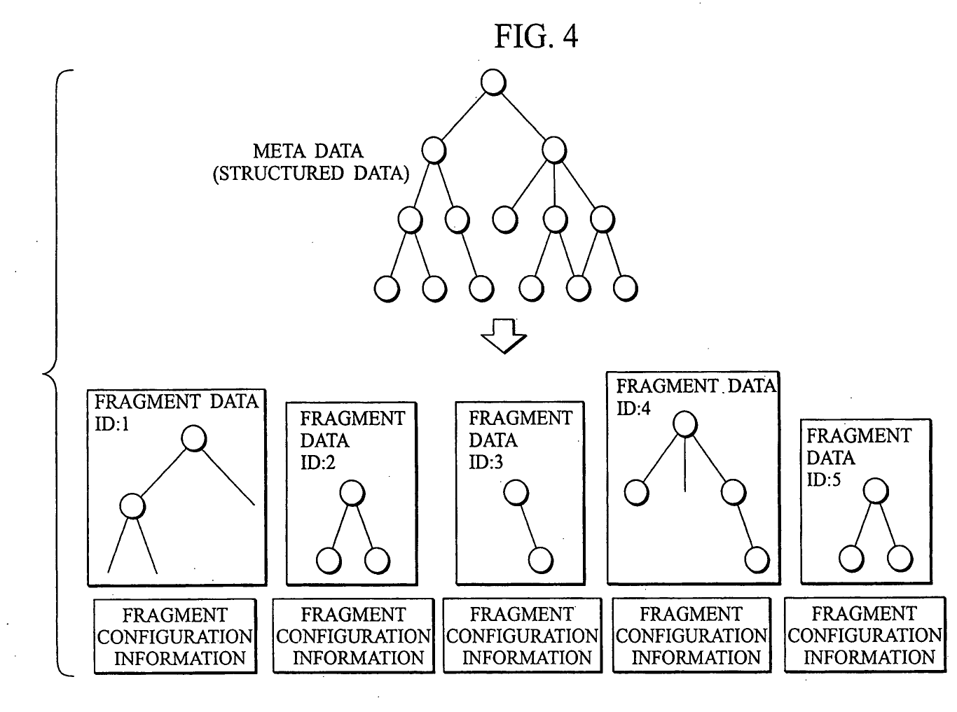

FIG. 4 is a diagram showing the outline of metadata fragmentation processing in this embodiment. Metadata (structured data) is divided into a plurality of fragment data and, at the same time, an ID uniquely identifying fragment data is attached to each fragment data. In addition, fragment configuration information corresponding to each fragment data is created. Instead of generating fragment data by dividing metadata, fragment data may be created considering metadata that will be generated through concatenation.

<Structure of Fragment Configuration Information>

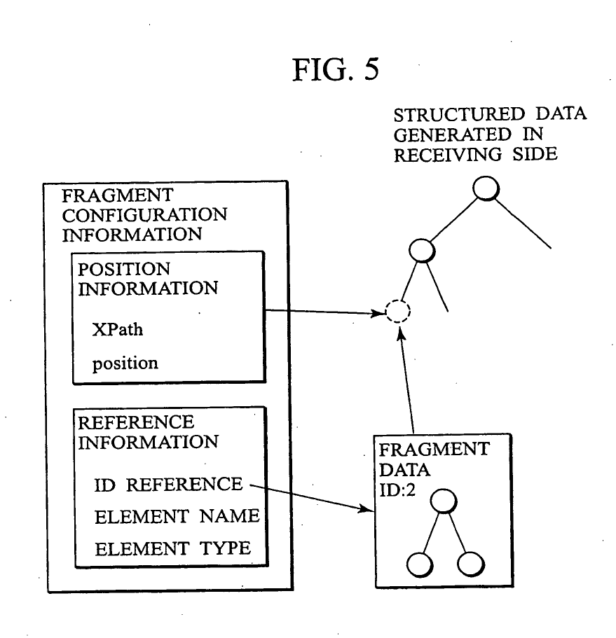

FIG. 5 is a diagram showing the structure of fragment configuration information in this embodiment. The fragment configuration information is composed of position information and reference information. The position information is composed of XPath and ‘position’. They are used to specify a position at which the highest node of fragment data is to be positioned in the structured data that will be generated in the receiving side. The reference information is composed of an ID reference, an element name, and an element type. The ID reference specifies fragment data using an ID attached to the fragment data. The element name describes the XML element name of the highest node of the fragment data. The element type describes the element type name in the XML schema of the highest node of the fragment data.

<Description of Position Information>

Next, how to specify a position using XPath and ‘position’, which from position information, will be described. XPath specifies a specific node in the structured data, which will be generated in the receiving side, using the XML path language (XPath). ‘position’ takes one of two values as its value, “prevSibling” or “lastChild”. When the ‘position’ value is “prevSibling”, the node specified by the position information becomes the previous sibling node of the node specified by XPath. When the ‘position’ value is “lastChild”, the node specified by the position information becomes the last child node of the node specified by XPath.

<Example of Position Information>

Next, how to specify position information will be described in detail using examples.

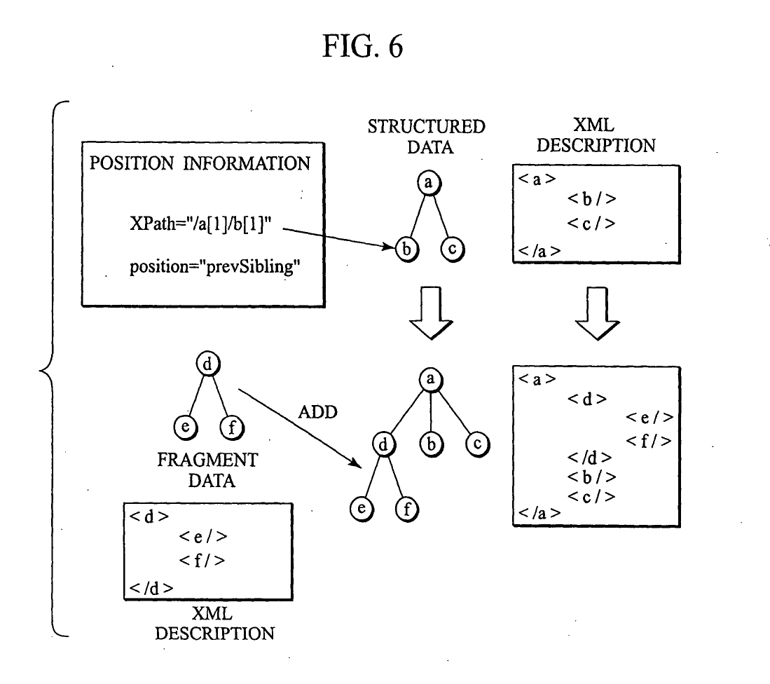

FIG. 6 shows an example of how to specify position information specifying the first child node of a node. To create the highest node ‘d’ of fragment data as the first child node of the node ‘a’ in the structured data, XPath specifies the node ‘b’ that is currently the first child node of the node ‘a’ with the value of ‘position’ set to “prevSibling”. Then, the highest node ‘d’ of the fragment data is positioned as the previous sibling node of the node ‘b’, that is, as the first child node of the node ‘a’.

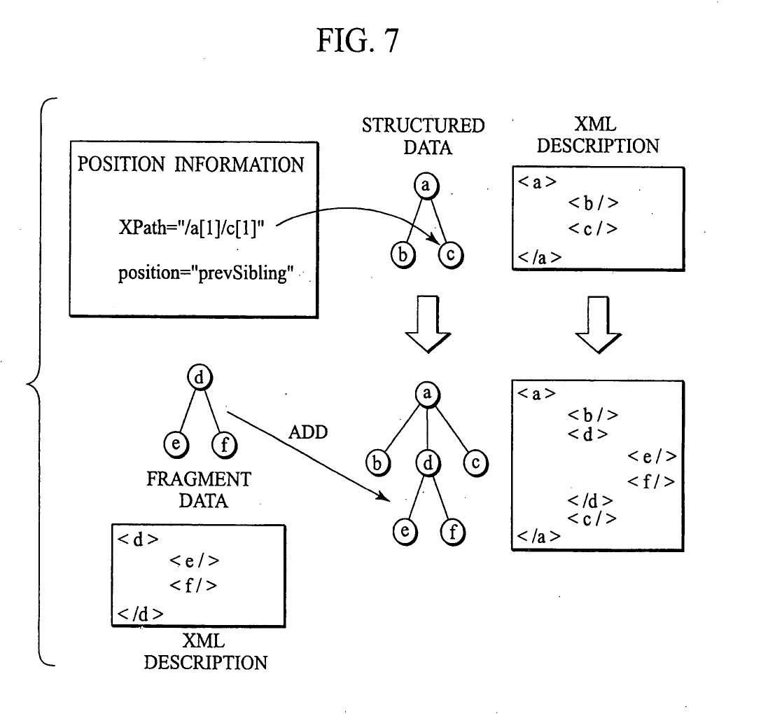

FIG. 7 is an example of how to specify position information specifying a child node other than the first and the last child nodes of a node. To position the highest node ‘d’ of fragment data as a child node other than the first and last child nodes of the node ‘a’ in the structured data, XPath specifies the child node ‘c’ of the node ‘a’ with the value of ‘position’ set to “prevSibling”. Then, the highest node ‘d’ of the fragment data is positioned as the previous sibling node of the node ‘c’, that is, as a child node of the node ‘a’.

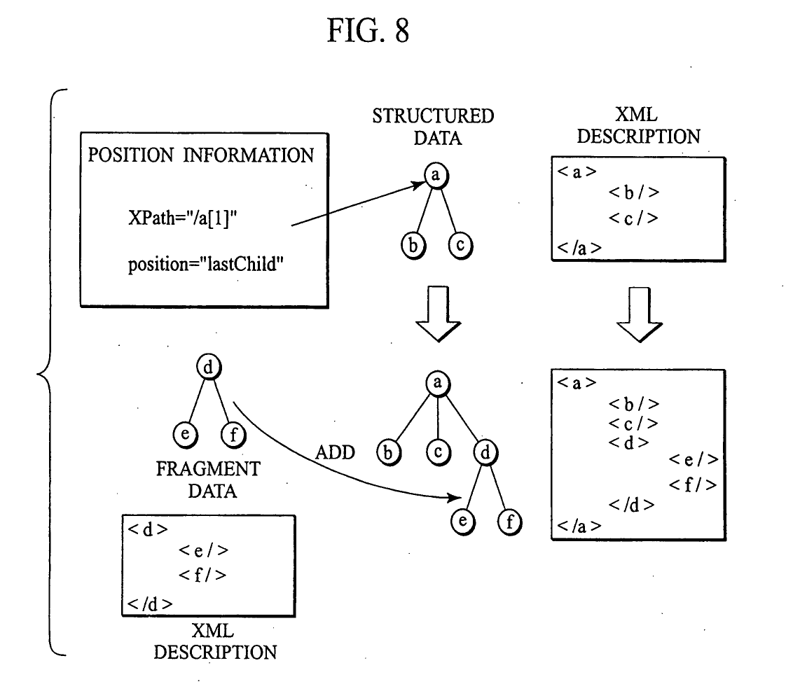

FIG. 8 is an example of how to specify position information specifying the last child node of anode. To create the highest node ‘d’ of fragment data as the last child node of the node ‘a’ in the structured data, XPath specifies the node ‘a’ with the value of ‘position’ set to “lastChild”. Then, the highest node ‘d’ of the fragment data is positioned as the last child node of the node ‘a’.

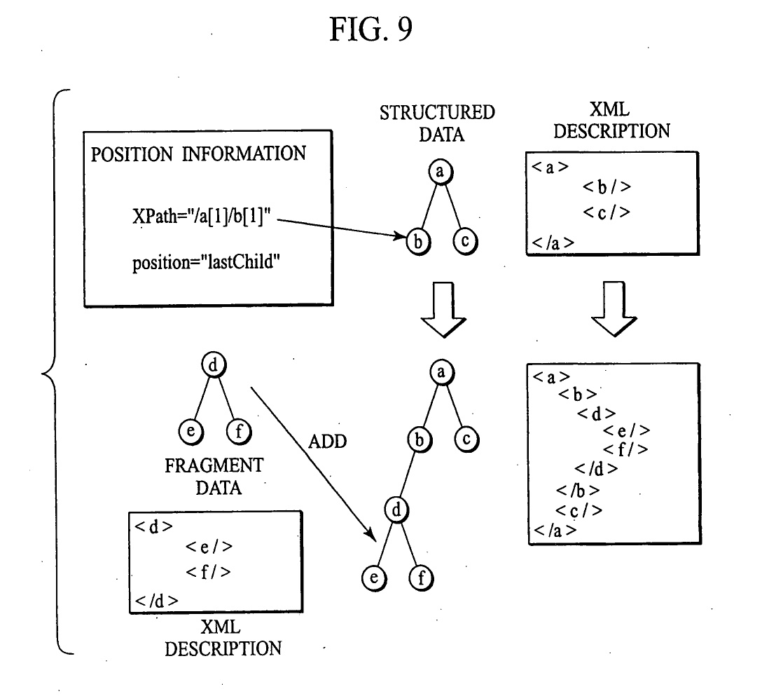

FIG. 9 shows an example of how to specify position information specifying a child node of a node that has no child node. To create the highest node ‘d’ of fragment data as a child node of the node ‘b’ in the structured data, XPath specifies the node ‘b’ with the value of ‘position’ set to “lastChild”. Then, the highest node ‘d’ of the fragment data is positioned as a child node of the node ‘b’.

<Binary Encoding of Fragment Configuration Information>

Information included in the fragment configuration information in this embodiment may be converted to binary data using appropriate means to represent the information as binary data.

<Transmission>

Next, how the transmitter 1 transmits content data and metadata in this embodiment will be described.

The transmitter 1 arranges a plurality of fragment data and the corresponding fragment configuration information in an appropriate order to create a metadata stream. The fragment data and the fragment configuration information may be arranged in any order; either the fragment data and the fragment configuration information may be mixed or all fragment configuration information is placed first followed by all fragment data. Note that the fragment data may be arranged in any order but that the fragment configuration information must be arranged in the depth first order or, in the breadth first order, of the nodes in the structured data indicated by the position information included in the fragment configuration information.

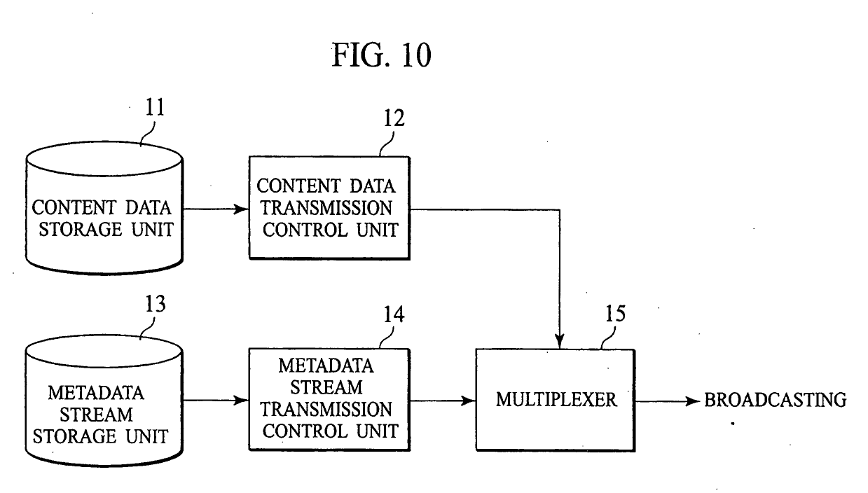

FIG. 10 is a diagram showing the configuration of a content data and metadata transmitting apparatus used by the transmitter 1.

A content data storage unit 11 stores content data, and a metadata stream storage unit 13 stores the metadata stream described above.

A content data transmission control unit 12 receives content data from the content data storage unit 11 according to a predetermined schedule and outputs it to a multiplexer 15.

A metadata stream transmission control unit 14 receives a metadata stream from the metadata stream storage unit 13 and outputs it to the multiplexer 15, based on the frequency and the period of predetermined carousel transmissions, to transmit the metadata stream in a carousel transmission mode.

The multiplexer 15 multiplexes the content data received from the content data transmission control unit 12 with the metadata stream received from the metadata stream transmission control unit 14 and outputs the multiplexed stream via broadcasting.

<Reception>

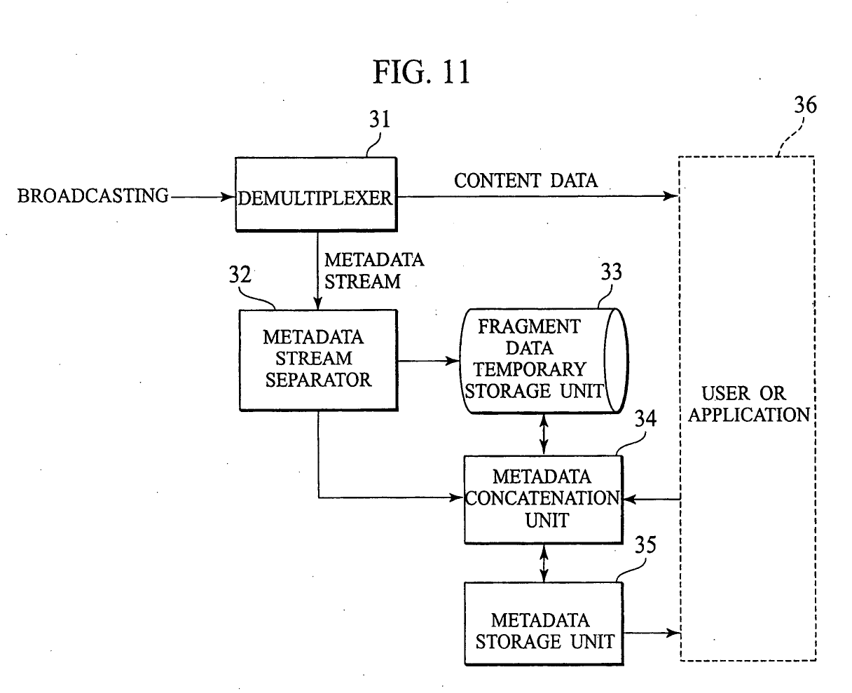

FIG. 11 is a diagram showing the configuration of a content data and metadata receiving apparatus used by the receiver 3.

A demultiplexer 31 demultiplexes a multiplexed stream, received via broadcasting, into content data and a metadata stream, outputs the content data to a user or an application 36, and outputs the metadata stream to a metadata stream separator 32.

The metadata stream separator 32 separates the metadata stream, received from the demultiplexer 31, into fragment data and fragment configuration information, outputs the fragment data to a fragment data temporary storage unit 33, and outputs the fragment configuration information to a metadata concatenation unit 34.

The fragment data temporary storage unit 33, composed, for example, of a memory, temporarily stores the fragment data received from the metadata stream separator 32. In response to a request for a list of IDs of fragment data from the metadata concatenation unit 34, the fragment data temporary storage unit 33 outputs the list of IDs of stored fragment data to the metadata concatenation unit 34. In response to a request for an ID of fragment data as well as the fragment data identified by the ID from the metadata concatenation unit 34, the fragment data temporary storage unit 33 outputs the fragment data identified by the ID to the metadata concatenation unit 34 and, at the same time, erases the fragment data from the memory.

The metadata concatenation unit 34 processes the fragment configuration information received from the metadata stream separator 32 according to the fragment configuration information processing method that will be described later and attaches the fragment configuration information, or the reference information included in the fragment configuration information, to the metadata (structured data) stored in a metadata storage unit 35. When instructed by the user or the application 36 to resolve the reference information in metadata stored in the metadata storage unit 35, the metadata concatenation unit 34 acquires the fragment data from the fragment data temporary storage unit 33 and attaches the acquired fragment data to the metadata according to the reference information processing method that will be described later and processes the related fragment configuration information.

The metadata storage unit 35 is a metadata-storing storage medium to or from which the metadata concatenation unit 34 writes and reads data. The user or the application 36 may also read data from the metadata storage unit 35.

If the user or the application 36 wants to get fragment data referenced by any reference information included in the metadata stored in the metadata storage unit 35, the user or the application 36 instructs the metadata concatenation unit 34 to resolve the reference information. In addition, if fragment data referenced by any reference information included in metadata, acquired by resolving reference information and read from the metadata storage unit 35, is required, the user or the application 36 repeatedly instructs the metadata concatenation unit 34 to resolve the reference information. If there is no reference information referencing necessary fragment data, the finally acquired metadata is used for the purposes.

<Method for Processing Fragment Configuration Information>

Next, the method for processing fragment configuration information will be described. First, the position information and the reference information are extracted from the fragment configuration information. When the node specified by XPath included in the position information is in the structured data (metadata) stored in the metadata storage unit, the reference information is added to the position specified by the position information (XPath and ‘position’). At that time, the reference information existing in the structured data is treated as an element having the element name included in the reference information. When the node specified by XPath included in the position information is not in the structured data stored in the metadata storage unit, the fragment configuration information is added as the last child node of the last node (this node should be the reference information) that is found by following all nodes in the structured data, beginning at the root node, according to XPath.

The method for processing fragment configuration information will be described in detail with reference to the drawings.

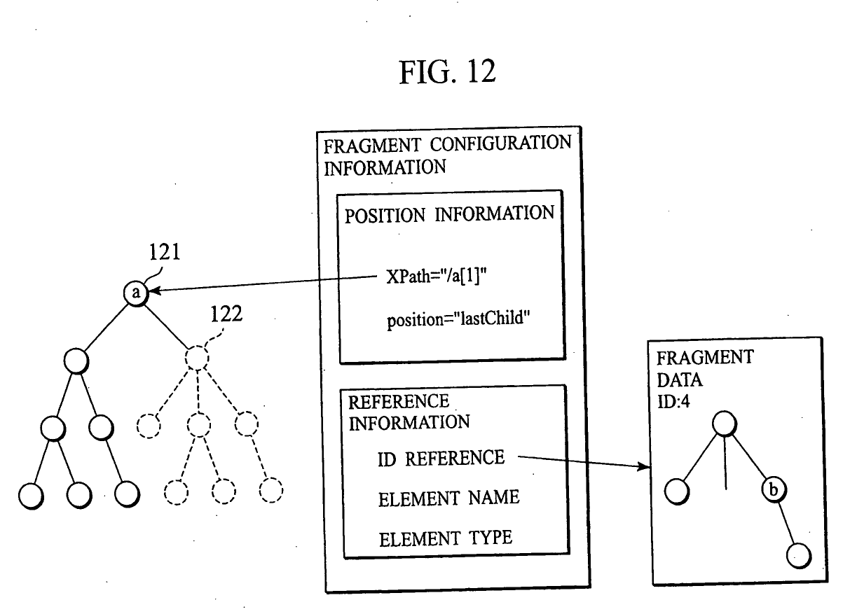

FIG. 12 shows an example of the method for processing fragment configuration information when the node specified by XPath included in the position information is in the structured data. XPath specifies a node 121, and the value of ‘position’ is “lastChild”. This means that the highest node of the fragment data should be positioned at a node 122, and the reference information is added to the node 122.

FIG. 13 shows an example of the method for processing fragment configuration information when XPath included in the position information specifies reference information in the structured data. Because the reference information existing at the position of a node 131 includes the element name ‘b’ of the highest node of fragment data to be positioned at the node 131, it is understood that XPath specifies the node 131. In addition, because the value of ‘position’ is “lastChild”, the reference information is added to the position of a node 132.

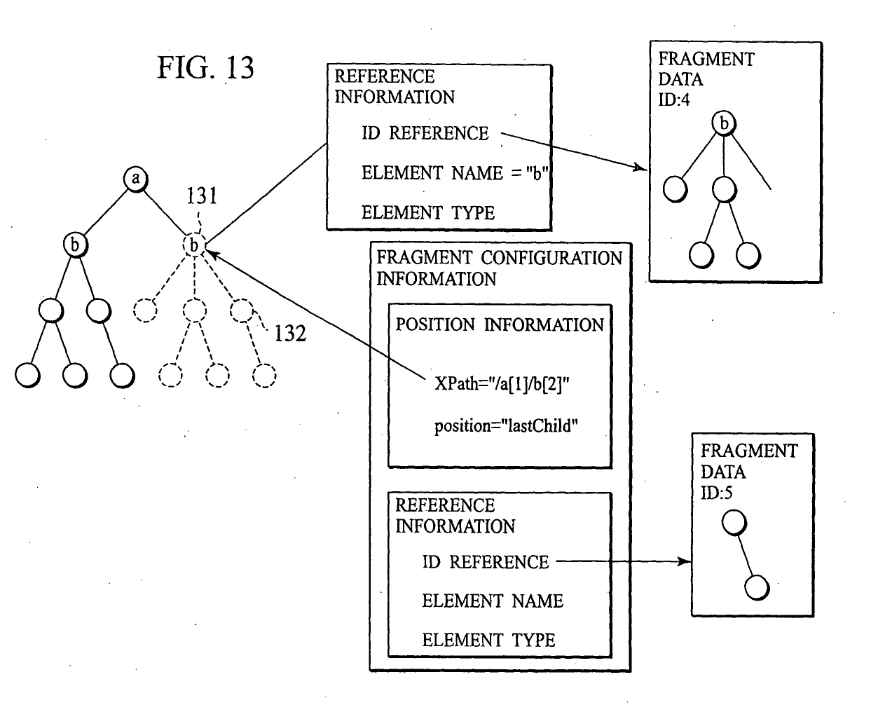

FIG. 14 shows an example of the method for processing fragment configuration information when the node specified by XPath included in the position information is not in the structured data. Because reference information exists in a node 141, the element name of the highest node of fragment data to be positioned at the node 141 is known. However, because XPath specifies the position of the node 141, the structured data may be followed from the root node to the node 141 according to Xpath but not any further. Therefore, the fragment configuration information is added as the last child node of the reference information existing at the position of the node 141.

<Resolving Reference Information>

Next, how reference information is resolved will be described. To resolve reference information, the fragment data specified by the ID included in the reference information is acquired, the reference information is deleted, and the fragment data is added to the position where the reference information was positioned. If the reference information has (one or more) fragment configuration information as its child node, the fragment data is first added and then the fragment configuration information is processed according to the fragment configuration information processing method described above (in order of appearance if there are many).

<Determining Whether Fragment Data is Required>

Whether fragment data is required is determined based on the element type included in the reference information. Because the format of XML elements and attributes included in the structured data is defined using XML schemas and because the element type included in the reference information is the XML schema element type of the highest node of the fragment data to be referenced, the outline contents of the fragment data can be acquired from the element type by interpreting the format definition of the structured data defined by the XML schemas. The user or the application 36 determines whether the fragment data is required, based on the outline contents.

### Second Embodiment

### Reference Only, Broadcasting and Internet

<System Configuration>

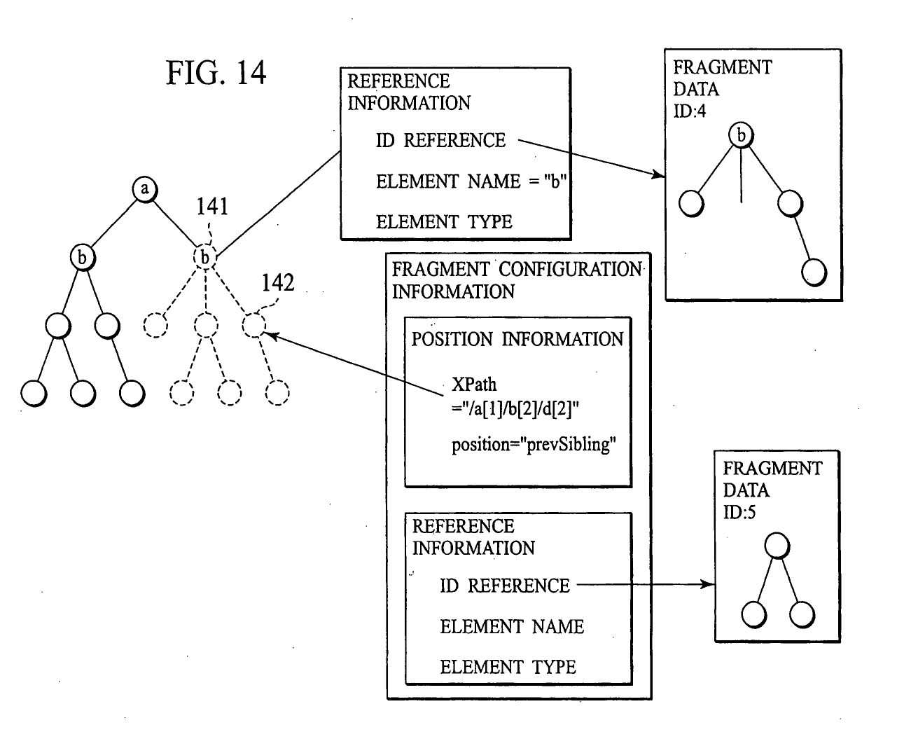

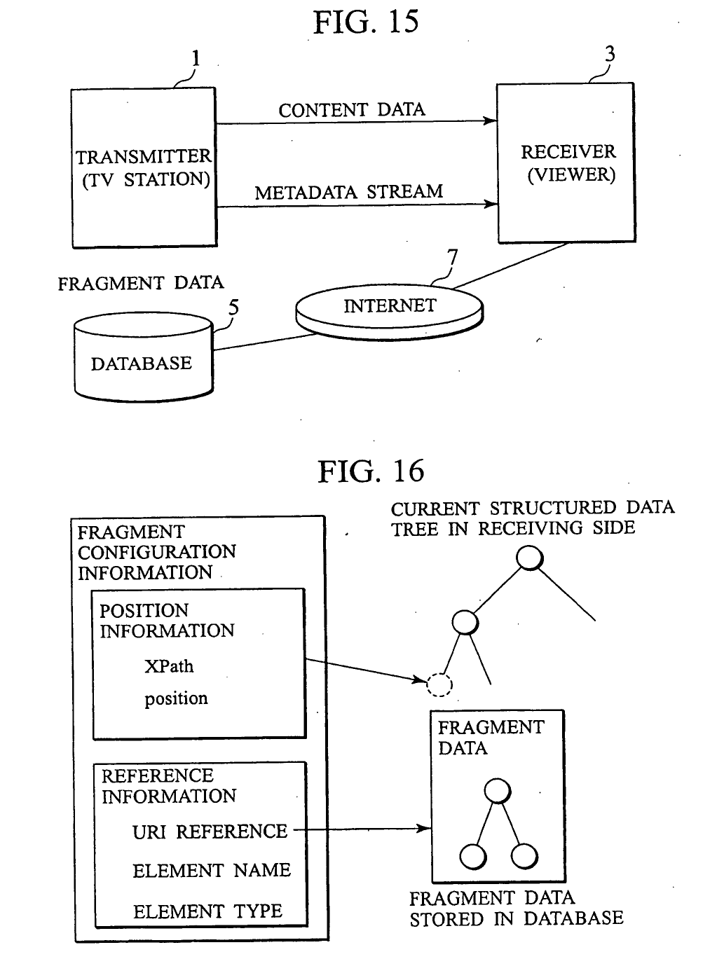

FIG. 15 is a diagram showing the configuration of a content data and metadata transmission/reception system in a second embodiment of the present invention. In this embodiment, a transmitter 1 transmits content data and a metadata stream via broadcasting and a receiver 3 receives them as in the system configuration of the first embodiment shown in FIG. 3. In addition, the transmitter 1 stores a part of fragment data in a database 5 connected to the Internet 7, and the receiver 3 acquires fragment data from the database 5 via the Internet 7.

The transmitter 1 creates content data and metadata (structured data) about the content data. The content data is transmitted to the receiver 3 via broadcasting. The metadata is divided into a plurality of fragment data and, at the same time, fragment configuration information for each fragment data is created. A metadata stream is created from a part of fragment data and all fragment configuration information, the created metadata stream is transmitted to the receiver 3 via broadcasting, and the remaining fragment data is stored in the database 5. The receiver 3 receives the content data and the metadata stream via broadcasting and extracts the fragment data and the fragment configuration information from the metadata stream. In addition, the receiver 3 acquires the fragment data from the database 5 via the Internet 7 and reconfigures the metadata from the fragment data and fragment configuration information. The reconfigured metadata is used for searching for, or viewing, content data.

<Description of Metadata (XML)>

The metadata used in this embodiment is the same as that used in the first embodiment.

<Fragmentation Processing>

The fragmentation processing method in this embodiment is the same as that used in the first embodiment. The difference is that an ID uniquely identifying fragment data is attached to the fragment data transmitted via broadcasting and that the fragment data stored in the database is stored in the file format with a unique file name attached to each fragment data. The database is built so that the fragment data stored in the database 5 can be referenced via the Internet using a URI (Uniform Resource Identifier).

<Structure of Fragment Configuration Information>

For the fragment configuration information corresponding to the fragment data transmitted via broadcasting, the structure of the fragment configuration information in this embodiment is the same as that of the fragment configuration information in the first embodiment. The overview is as shown in FIG. 5. On the other hand, for the fragment configuration information corresponding to the fragment data stored in the database 5 connected to the Internet 7, the structure of the fragment configuration information is as shown in FIG. 16. Instead of the ID reference in FIG. 5, the URI reference is included in the reference information to specify the fragment data using the URI.

<Transmission Via Broadcasting>

The content data and metadata stream transmission method used by the transmitter 1 in this embodiment is the same as the content data and metadata stream transmission method in the first embodiment, except that only a part of fragment data is included in the metadata stream.

<Transmission Via the Internet>

A part of fragment data not transmitted via broadcasting is stored in the database 5 connected to the Internet 7 as described above. In response to a URI and a fragment data file acquisition request from the receiver 3 connected to the Internet 7, the database 5 transmits the fragment data file corresponding to the URI to the receiver 3.

<Reception>

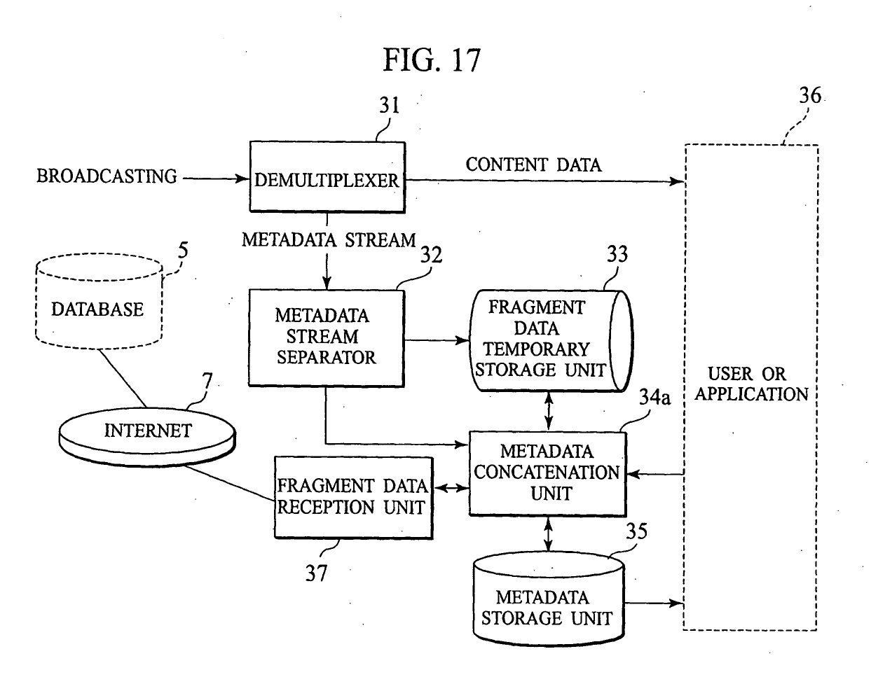

FIG. 17 is a diagram showing the configuration of a content data and metadata receiving apparatus used by the receiver.

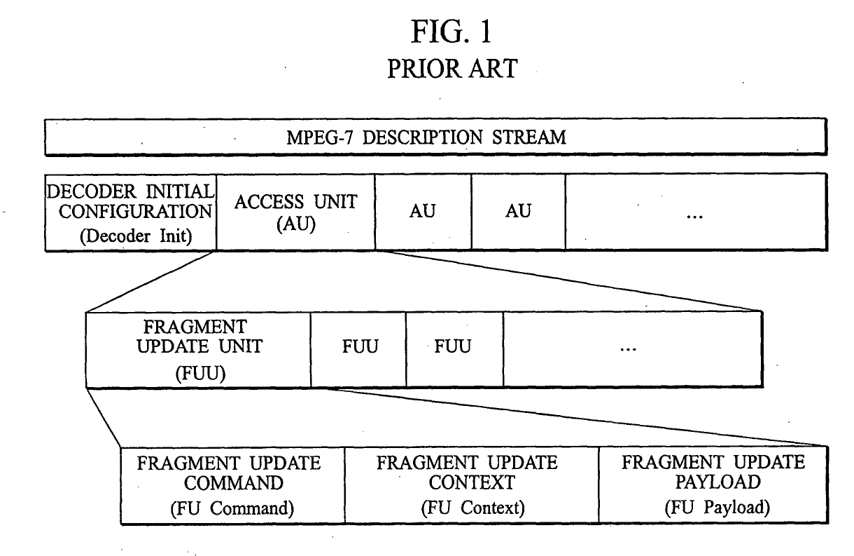

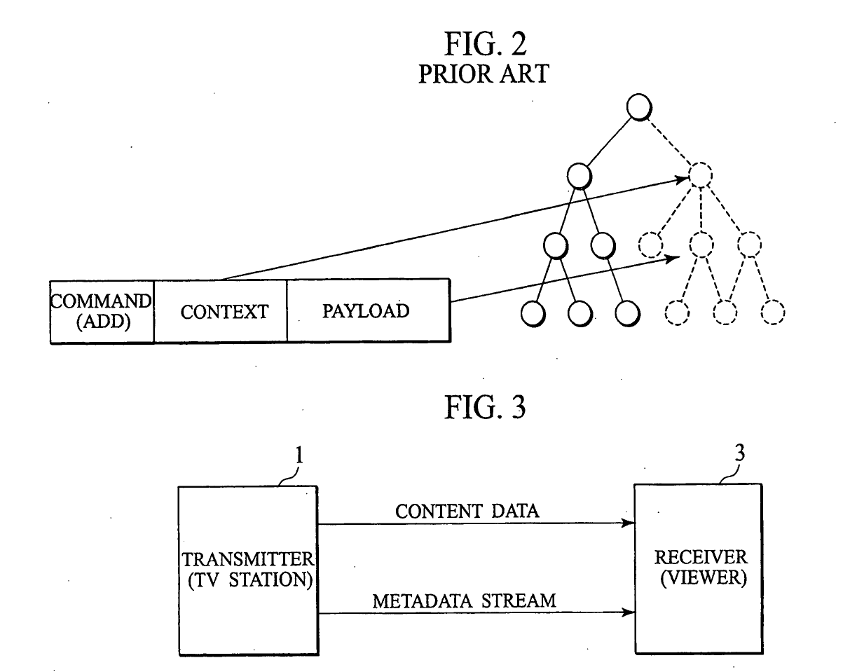

The configuration and the operation of a demultiplexer 31, a metadata stream separator 32, a fragment data temporary storage unit 33, a metadata storage unit 35, and a user or an application 36 in the configuration diagram of the content data and metadata receiving apparatus in FIG. 17 are the same as those in the configuration diagram of the content data and metadata receiving apparatus in the first embodiment in FIG. 1.

The configuration and the operation of a metadata concatenation unit 34a are the same as those of the metadata concatenation unit 34 in the configuration diagram of the content data and metadata receiving apparatus in the first embodiment in FIG. 11. The difference is that, if the ID reference of the reference information specifies fragment data when resolving the reference information, the metadata concatenation unit 34a acquires the fragment data from the fragment data temporary storage unit 33 as in the first embodiment and that, if the URI reference of the reference information specifies fragment data, the metadata concatenation unit 34a instructs a fragment data reception unit 37 to receive the fragment data identified by the URI and acquires the fragment data from the fragment data reception unit 37.

In response to an instruction from the metadata concatenation unit 34a to receive the fragment data identified by a URI, the fragment data reception unit 37 transmits a URI and an acquisition request for the fragment data identified by the URI to the database 5 via the Internet 7, receives the fragment data from the database 5, and outputs the received fragment data to the metadata concatenation unit 34a.

### Third Embodiment

### Reference Only, Internet

<System Configuration>

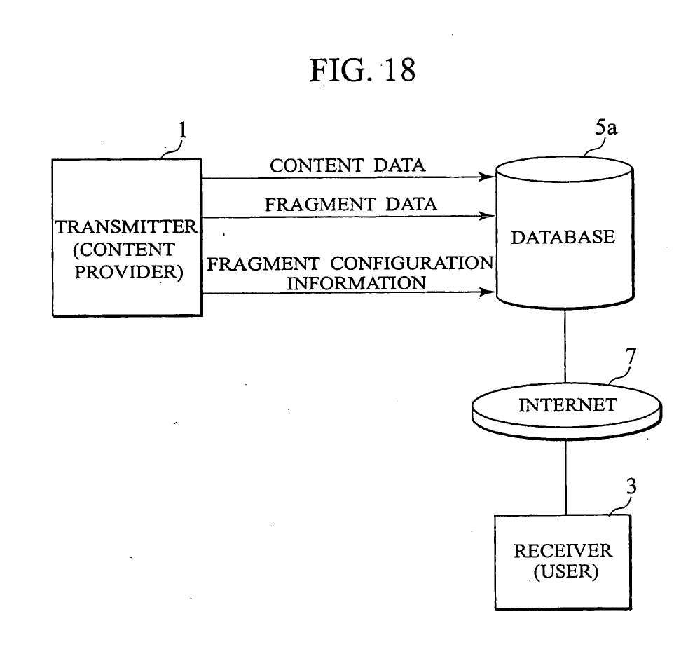

FIG. 18 is a diagram showing the configuration of a content data and metadata transmission/reception system in a third embodiment of the present invention. In this embodiment, a transmitter (content provider) 1 stores content data (video, audio, and so on) and structured metadata (structured data) on the content data in a database 5a connected to the Internet 7, and a receiver (user) 3 acquires the data from the database 5a via the Internet 7.

The transmitter 1 creates content data and metadata on the content data. The content data is stored in the database 5a. The metadata is divided into a plurality of fragment data, fragment configuration information corresponding to each fragment data is created, and the fragment data and the fragment configuration information are stored in the database 5a. The receiver 3 acquires the content data, fragment data, and fragment configuration information from the database 5a via the Internet 7 and reconfigures the metadata from the fragment data and the fragment configuration information. The reconfigured metadata is used for searching for the content data and for viewing.

<Description of Metadata (XML)>

The metadata used in this embodiment is the same as that used in the first embodiment.

<Fragmentation Processing>

The fragmentation processing method used in this embodiment is the same as that used in the first embodiment except that an ID is not attached to fragment data. The fragment data is stored in the database 5a in the file format with a unique file name attached. The fragment data stored in the database 5a can be referenced using a URI via the Internet 7. All fragment configuration information, which is arranged in the depth first order or the breadth first order of the nodes in the structured data specified by the position information included in the fragment configuration information, forms a fragment configuration information stream. This fragment configuration information stream is stored in the database 5a.

<Structure of Fragment Configuration Information>

The structure of the fragment configuration information in this embodiment is the same as that of the fragment configuration information generated when the corresponding fragment data is stored in the database connected to the Internet in the second embodiment in FIG. 16.

<Transmission Via the Internet>

The content data, fragment data, and fragment configuration information are stored in the database 5a connected to the Internet 7 as described above. In response to a URI and a content data, fragment data, or fragment configuration information file acquisition request from the receiver 3 connected to the Internet 7, the database 5a transmits the file corresponding to the URI to the receiver 3.

<Reception>

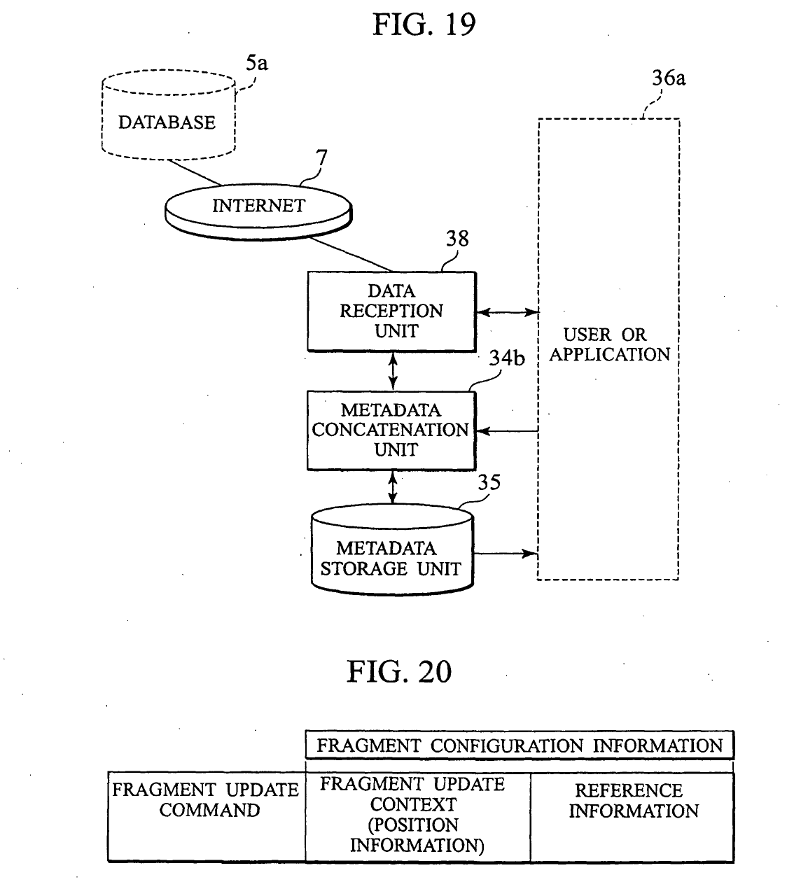

FIG. 19 is a diagram showing the configuration of a content data and metadata receiving apparatus used by the receiver 3.

In response to the URI of content data and an acquisition request for the content data corresponding to the URI from a user or an application 36a, a data reception unit 38 requests the database 5a, via the Internet 7, to transmit the content data corresponding to the URI. The data reception unit 38 receives the content data corresponding to the URI transmitted from the database 5a and outputs the received content data to the user or the application 36a. In response to an acquisition request for a fragment configuration information stream, or to a URI and an acquisition request for the fragment data corresponding to the URI, from a metadata concatenation unit 34b, the data reception unit 38 requests the database 5a, via the Internet 7, to transmit the fragment configuration information stream or the fragment data corresponding to the URI, receives the fragment configuration information stream or the fragment data corresponding to the URI transmitted from the database 5a, and outputs the received fragment configuration information stream or the fragment data corresponding to the URI to the metadata concatenation unit 34b.

The metadata concatenation unit 34b first requests the data reception unit 38 to acquire the fragment configuration information stream and sequentially processes the fragment configuration information included in the fragment configuration information stream received from the data reception unit 38. The fragment configuration information processing method is the same as the fragment configuration information processing method in the first embodiment. In response to a request to resolve reference information in the metadata stored in the metadata storage unit 35 from the user or the application 36a, the metadata concatenation unit 34b requests the data reception unit 38 to acquire the fragment data corresponding to the URI included in the reference information, adds the fragment data, received from the data reception unit 38, to the metadata, and processes the related fragment configuration information according to the reference information processing method. The reference information processing method is the same as the reference information processing method in the first embodiment.

The configuration and the operation of the metadata storage unit 35 are the same as those of the metadata storage unit 35 in the configuration diagram of the content data and metadata receiving apparatus in the first embodiment in FIG. 11.

The configuration and the operation of the user or the application 36a are the same as those of the user or the application 36 in the configuration diagram of the content data and metadata receiving apparatus in the first embodiment in FIG. 11. The difference is that, when content data is required, the user or the application 36a transmits the URI of the content data and an acquisition request for the content data corresponding to the URI to the data reception unit 38 and receives the content data from the data reception unit 38.

### Fourth Embodiment

### Reference and Command, Broadcasting

<System Configuration>

A content data and metadata transmission/reception system in a fourth embodiment of the present invention implements both the dynamic generation/update of metadata by the sending side using the MPEG-7 system and the active acquisition/concatenation of fragment data by the receiving side using the fragment configuration information according to the present invention.

The configuration of the content data and metadata transmission system in this embodiment is the same as that of the content data and metadata transmission system in the first embodiment in FIG. 3. The difference is the structure of the metadata stream.

<Metadata Stream>

The metadata stream used in this embodiment is an extended metadata stream of the MPEG-7 description stream in the MPEG-7 system in FIG. 1. The metadata stream in this embodiment is composed of a decoder initial configuration followed by a plurality of access units. An access unit is composed of a plurality of fragment update units. In addition to a fragment update unit (1) with the same structure as that of a fragment update unit in the MPEG-7 system, two types of fragment update units are used in this embodiment: a fragment update unit (2) for transmitting fragment configuration information and a fragment update unit (3) including only fragment data. FIG. 20 is a diagram showing the configuration of the fragment update unit (2). The fragment update unit (2) is composed of a fragment update command, a fragment update context, and reference information. The fragment update context in the MPEG-7 system has the same structure as that of position information included in the fragment configuration information of the present invention, with the fragment update context and the reference information forming the fragment configuration information.

<Fragmentation Processing>

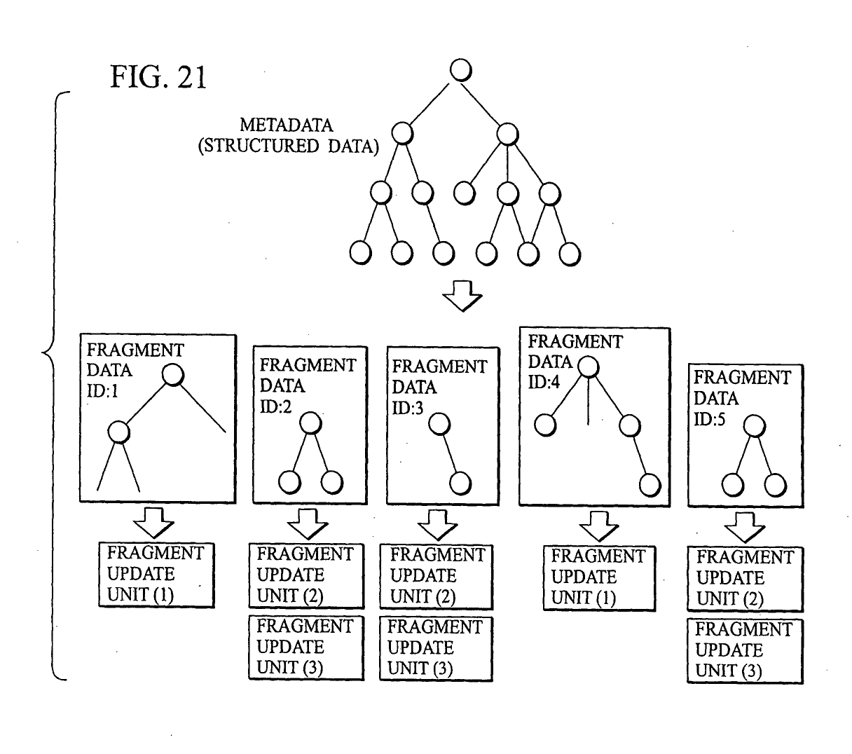

FIG. 21 is a diagram showing the overview of metadata (structured data) fragmentation processing and metadata stream creation in this embodiment. Metadata is divided into a plurality of fragment data. For each fragment data, either the fragment update command (the “add” command is used in this example) and the fragment update context (position information) are added to create the fragment update unit (1) (in this case, the fragment data is the fragment update payload) or the fragment configuration information is created as in the fragmentation processing in the first embodiment and the fragment update unit (2), to which the fragment update command (in this example, the “add” command is used) is added, and the fragment update unit (3) which includes only fragment data are created. For convenience, the fragment data included in the fragment update unit (3) is called the first fragment data, and the fragment data included in the fragment update unit (1) is called the second fragment data.

Fragment data may also be created, not by dividing metadata, but by considering metadata to be created through concatenation so that either fragment update units (1) or fragment update units (2) and fragment update units (3) are created. In addition, the “replace” command, “delete” command, or “reset” command may be used for the fragment update command to dynamically update the structured metadata tree in the receiving side. An appropriate number of fragment update units (1), fragment update units (2), and fragment update units (3), created in the above processing, are arranged to create each access unit. The created access units, preceded by the decoder initial configuration, are arranged to create a metadata stream.

<Transmission>

The configuration of a content data and metadata transmitting apparatus used by the transmitter in this embodiment is the same as that of the content data and metadata transmitting apparatus used by the transmitter in the first embodiment in FIG. 10.

<Reception>

The configuration of a content data and metadata receiving apparatus used by the receiver in this embodiment is the same as that of the content data and metadata receiving apparatus used by the receiver in the first embodiment in FIG. 11 except the operation of the metadata stream separator 32 and the metadata concatenation unit 34.

The metadata stream separator 32 separates a metadata stream, received from the demultiplexer 31, into fragment update units (1), fragment update units (2), and fragment update units (3), outputs the fragment update units (1) and fragment update units (2) to the metadata concatenation unit 34, extracts fragment data from the fragment update units (3), and outputs the fragment data to the fragment data temporary storage unit 33.

The metadata concatenation unit 34 interprets each fragment update unit (1) received from the metadata stream separator 32. When the fragment update command is the ‘add’ command, the metadata concatenation unit 34 adds the fragment data included in the fragment update payload (included in the fragment update unit (1)) to the fragment-update-context specified position in the metadata stored in the metadata storage unit 35. When the fragment update command is the “replace” command”, the metadata concatenation unit 34 replaces the part following the fragment-update-context specified position in the metadata stored in the metadata storage unit 35 with the fragment data included in the fragment update payload. When the fragment update command is the “delete” command”, the metadata concatenation unit 34 deletes the part following the fragment-update-context specified position in the metadata stored in the metadata storage unit 35. When the fragment update command is the “reset” command”, the metadata concatenation unit 34 resets the metadata stored in the metadata storage unit 35 to the predetermined initial state. If there is no node at the fragment-update-context specified position in the metadata during the above processing, the corresponding higher reference information in the metadata is resolved until the fragment data including the node is acquired. The resolving method for the reference information is the same as that in the first embodiment.

The metadata concatenation unit 34 extracts the fragment update command and the fragment configuration information (fragment configuration context, that is, position information and reference information) from the fragment update unit (2) received from the metadata stream separator 32, processes the fragment update command in the same way as described above, and processes the fragment configuration information in the same way as the fragment configuration information is processed in the first embodiment.

When a request is received from the user or the application 36 to resolve reference information in the structured metadata tree stored in the metadata storage unit 35, the metadata concatenation unit 34 resolves the reference information in the same way as reference information is resolved in the first embodiment.

### Fifth Embodiment

### Reference and Command, Broadcasting and Internet

<System Configuration>

A content data and metadata transmission/reception system in a fifth embodiment of the present invention implements both the dynamic generation/update of metadata at the transmitting side using the MPEG-7 system and the active acquisition/concatenation of fragment data at the receiving side using the fragment configuration information according to the present invention at the same time.

The configuration of the content data and metadata transmission system in this embodiment is the same as that of the content data and metadata transmission system in the second embodiment in FIG. 15 except the structure of the metadata stream.

<Metadata Stream>

The structure of the metadata stream in this embodiment is the same as that of the metadata stream in the fourth embodiment. Note that, as in the second embodiment, a part of fragment data is not included in the metadata stream but is stored in a database connected to the Internet.

<Transmission>

The configuration of the content data and metadata transmitting apparatus used by the transmitter in this embodiment is the same as that of the content data and metadata transmitting apparatus used by the transmitter in the second embodiment in FIG. 15.

<Reception>

The configuration of the content data and metadata receiving apparatus used by the receiver in this embodiment is the same as that of the content data and metadata receiving apparatus used by the receiver in the second embodiment in FIG. 17 except the operation of the metadata stream separator 32 and the metadata concatenation unit 34a.

The operation of the metadata stream separator 32 is the same as that of the metadata stream separator 32 of the content data and metadata receiving apparatus used by the receiver in the fourth embodiment.

The operation of the metadata concatenation unit 34a is the same as that of the metadata concatenation unit 34a of the content data and metadata receiving apparatus used by the receiver in the fourth embodiment. The difference is from where to acquire fragment data. That is, when the ID reference is used in the reference information to specify fragment data for resolving the reference information, the fragment data is acquired from the fragment data temporary storage unit as in the fourth embodiment; when the URI reference is used in the reference information to specify fragment data, the fragment data reception unit 37 is requested to receive the fragment data identified by the URI to acquire the fragment data from the fragment data reception unit 37.

### <<Reception Program that Functions as Receiving Apparatus>>

The following describes in detail a structured data reception program that implements the receiving apparatus in each embodiment described above on a computer using the second embodiment as an example.

<Reception System>

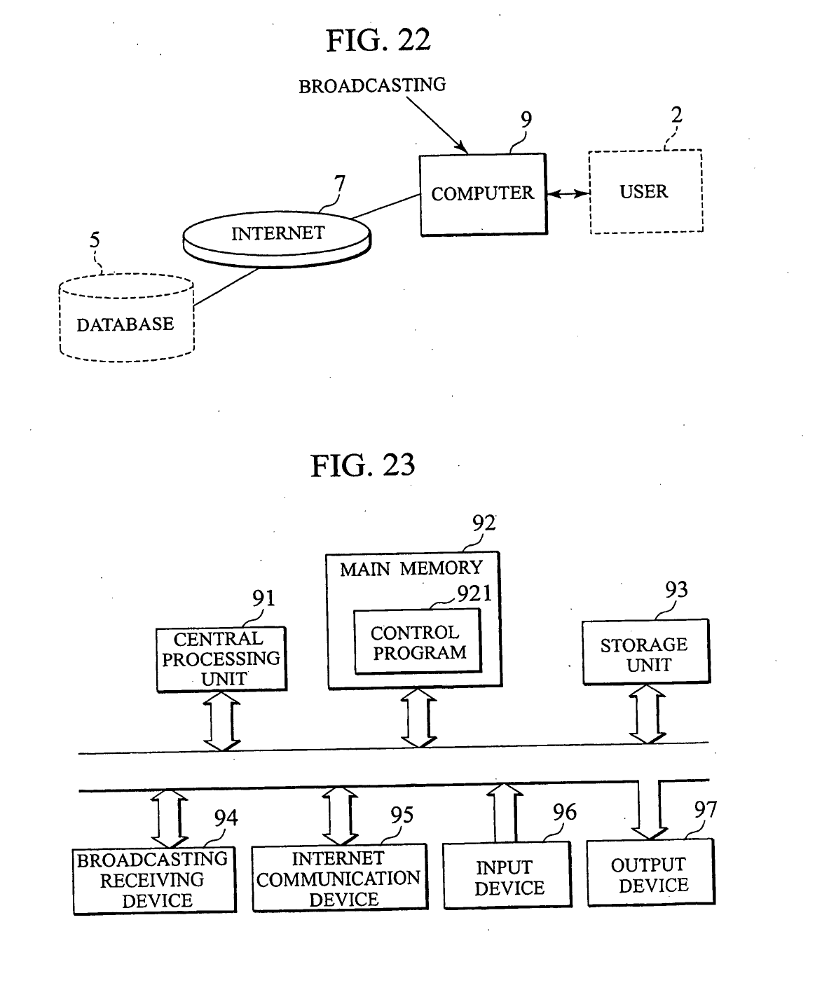

As shown in FIG. 22, a computer 9 receives content data and a metadata stream via broadcasting and, at the same time, receives fragment data from the database 5 via the Internet 7 in the second embodiment. In addition, the computer 9 reconfigures the metadata from the metadata stream and the fragment data and stores the reconfigured metadata in the internal storage unit. A user 2 operates the computer 9 to search for contents using the metadata or to view the contents and, at the same time, display the metadata.

<Processing Flow>

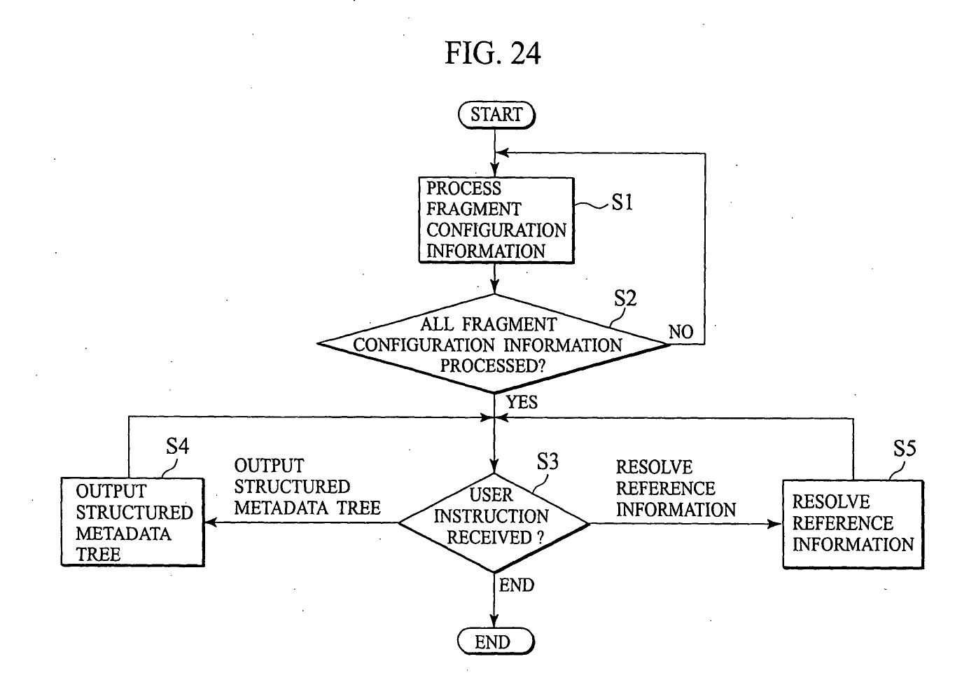

FIG. 23 is a diagram showing the configuration of the computer 9, and FIG. 24 shows the flow of processing in the computer.

First, in response to a command from a control program (structured data reception program) 921 in a main memory 92, a central processing unit 91 demultiplexes the multiplexed stream, received from a broadcasting receiving apparatus, into content data and a metadata stream, separates the metadata stream into fragment data and fragment configuration information, and sequentially processes the separated fragment configuration information (step S1). At this time, the content data and the fragment data, separated in parallel, are stored in a storage unit 93.

The fragment configuration information is processed in the same way as it is processed in the second embodiment except that the metadata is created in the storage unit 93.

Next, the central processing unit 91 checks if all fragment configuration information has been processed (step S2). If all fragment configuration information has not yet been processed, the central processing unit 91 continues processing the fragment configuration information (step S1); if all fragment configuration information has been processed, the central processing unit 91 waits for the user 2 to enter an instruction from an input device 96 (step S3).

In response to an instruction from the user 2, the central processing unit 91 outputs the metadata to an output device 97 if the instruction specifies the output of metadata (step S4). If the instruction from the user 2 specifies the resolving of reference information, the central processing unit 91 resolves the user-instructed reference information in the metadata stored in the storage unit 93 (step S5). The reference information is resolved in the same way as reference information is resolved in the second embodiment. If the fragment data referenced by the reference information is included in the metadata stream transmitted via broadcasting, the corresponding fragment data is acquired from that stored in the storage unit 93: if the fragment data referenced by the reference information is that stored in the database 5 connected to the Internet 7, an Internet communication device 95 acquires the corresponding fragment data from the database 5. When the instruction from the user 2 specifies the end of processing, the processing ends.

A receiving apparatus used in the embodiments other than the second embodiment can also be executed on a computer by a structured data reception program.

<Others>

The structured data reception program may be read into a computer from a computer readable recording medium recording therein the program or may be downloaded into a computer via a communication network.

### Sixth Embodiment

### Reference Information References a Stream

<System Configuration>

In a content data and metadata transmission/reception system in a sixth embodiment of the present invention, the reference information in the fragment configuration information references not only fragment data but also another metadata stream. Metadata (structured data) is transmitted in a plurality of streams, and the receiving side receives the plurality of streams recursively.

The configuration of the content data and metadata transmission system in this embodiment is the same as that of the content data and metadata transmission system in the first embodiment in FIG. 3 except the fragmentation processing, transmission method, and reception method.

<Fragmentation Processing>

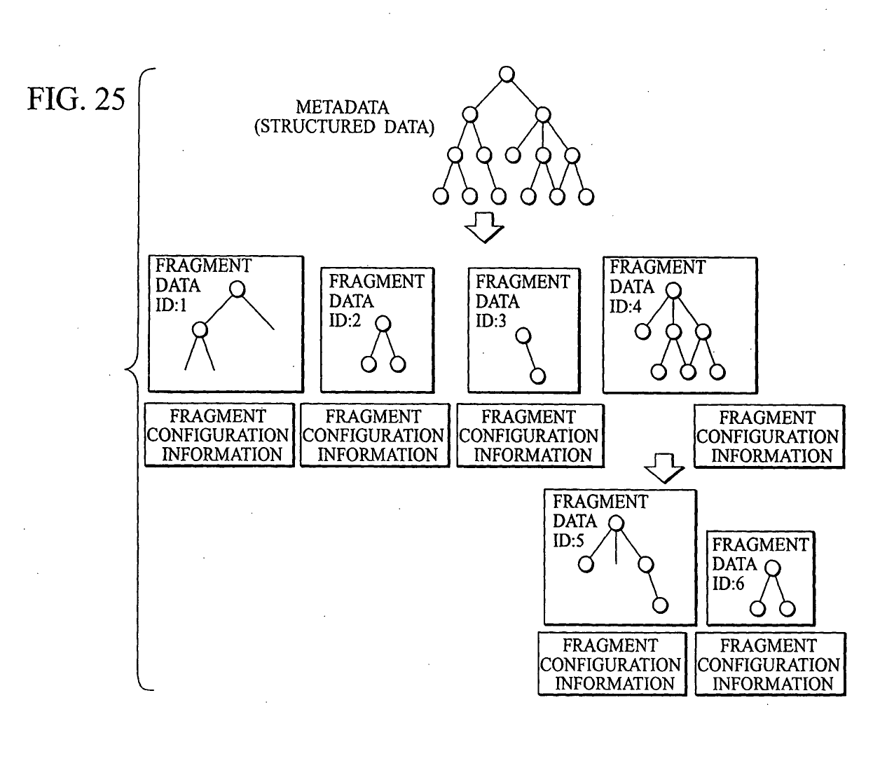

FIG. 25 is a diagram showing the overview of metadata fragmentation processing in this embodiment. The metadata (structured data) is divided into a plurality of fragment data, an ID uniquely identifying each fragment data is attached to each fragment data, and the corresponding fragment configuration information is created for each fragment data. The similar fragmentation processing may be further performed for the generated fragment data to subdivide it into pieces of smaller fragment data. Fragmentation processing may be repeated recursively in any number of stages, for example, by subdividing fragment data generated in the second-stage fragmentation processing. At this time, the position information included in the fragment configuration information created in the fragmentation processing in the second and the following stages indicates, not a position in the original metadata (structured data), but a position in the structured data generated by the fragmentation processing in that stage. Instead of generating fragment data by dividing metadata, fragment data may be created considering metadata that will be generated through concatenation.

<Transmission>

The configuration of a content data and metadata transmitting apparatus used by the transmitter in this embodiment is the same as that of the content data and metadata transmitting apparatus in the first embodiment in FIG. 10 except the method for configuring a metadata stream.

The transmitter arranges a plurality of fragment data and the corresponding fragment configuration information in an appropriate order to create a metadata stream. A plurality of independent metadata streams are created, one for each recursively repeated fragmentation processing. Information included in a metadata stream corresponding to specific fragmentation processing is composed of all fragment data which is generated in that fragmentation processing but for which fragmentation processing is not performed recursively and all fragment configuration information. In addition, an ID attached to the fragment data, for which the corresponding fragmentation processing is performed, is added to the metadata stream. To the highest metadata stream, an ID indicating that the metadata stream is highest is added.

<Reception>

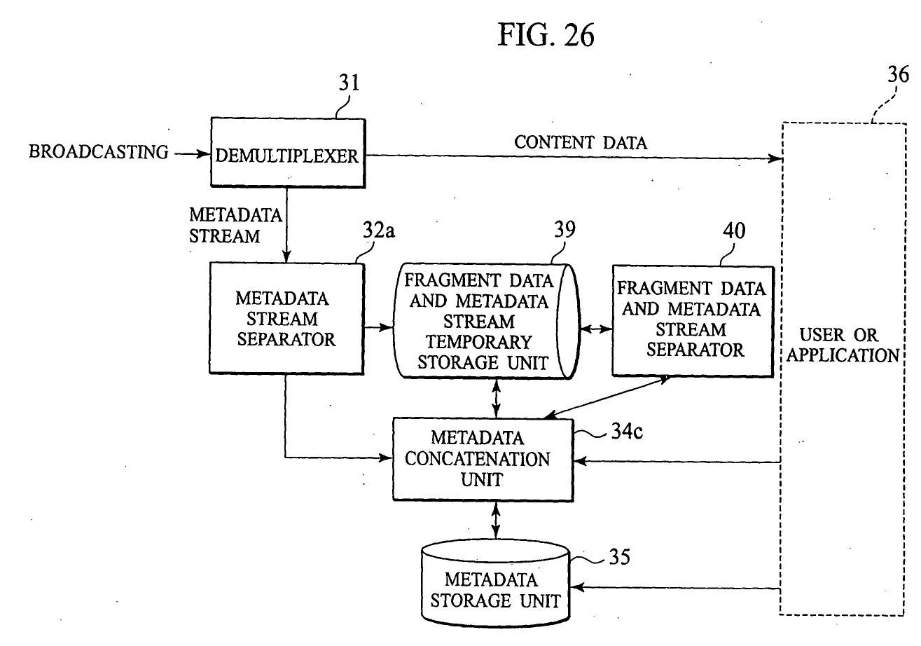

FIG. 26 is a diagram showing the configuration of a content data and metadata receiving apparatus used by the receiver.

The configuration and the operation of a demultiplexer 31, a metadata storage unit 35, and a user or an application 36 in the configuration diagram of the content data and metadata receiving apparatus are the same as those of the content data and metadata receiving apparatus in the first embodiment in FIG. 11.

A metadata stream separator 32a separates the highest metadata stream, one of a plurality of metadata streams received from the demultiplexer 31, into fragment data and fragment configuration information, outputs the fragment data to a fragment data and metadata stream temporary storage unit 39, and outputs the fragment configuration information to a metadata concatenation unit 34c. In addition, the metadata stream separator 32a outputs all streams other than the highest metadata stream directly to the fragment data and metadata stream temporary storage unit 39.

The fragment data and metadata stream temporary storage unit 39, composed, for example, of a memory, temporarily stores the fragment data and metadata streams, received from the metadata stream separator 32a, and the fragment data received from a fragment data and metadata stream separator 40. When the list of IDs of fragment data and metadata streams is requested by the metadata concatenation unit 34c, the fragment data and metadata stream temporary storage unit 39 outputs the list of IDs of stored fragment data and metadata streams to the metadata concatenation unit 34c. When the ID of fragment data or a metadata stream, as well as the fragment data or the metadata stream identified by the ID, is requested from the fragment data and metadata stream separator 40, the fragment data and metadata stream temporary storage unit 39 outputs the fragment data or the metadata stream identified by the ID to the fragment data and metadata stream separator 40 and, at the same time, erases the fragment data and the metadata stream from the memory.

When the ID of fragment data or a metadata stream, as well as the fragment data or the metadata stream identified by the ID, is requested by the metadata concatenation unit 34c, the fragment data and metadata stream separator 40 requests the fragment data and metadata stream temporary storage unit 39 to transmit the fragment data or the metadata stream identified by the ID and receives the fragment data or the metadata stream output by the fragment data and metadata stream temporary storage unit 39. In addition, when the received data is fragment data, the fragment data and metadata stream separator 40 outputs the fragment data to the metadata concatenation unit 34c. When the received data is a metadata stream, the fragment data and metadata stream separator 40 separates the metadata stream into (a plurality of) fragment data and (a plurality of) fragment configuration information, outputs the fragment data to the fragment data and metadata stream temporary storage unit 39, and outputs the fragment configuration information to the metadata concatenation unit 34c.

The metadata concatenation unit 34c processes the fragment configuration information received from the metadata stream separator 32a in the same way as the fragment configuration information is processed in the first embodiment and adds the fragment configuration information or the reference information included in the fragment configuration information to the metadata (structured data) stored in the metadata storage unit 35. When the user or the application 36 requests to resolve reference information in the metadata stored in the metadata storage unit 35, the metadata concatenation unit 34c acquires the fragment data from the fragment data and metadata stream separator 40 and adds it to the metadata in the same way as reference information is processed in the first embodiment and, at the same time, processes the related fragment configuration information. When the data acquired from the fragment data and metadata stream separator 40 is (a plurality of) fragment configuration information, the metadata concatenation unit 34c processes the fragment configuration information in the same way as the fragment configuration information is processed in the first embodiment, stores the fragment configuration information or the reference information included in the fragment configuration information in the metadata storage unit 35 (separately from already stored metadata), and adds the metadata acquired by processing all the fragment configuration information to a predetermined position in the original metadata. In addition, when the fragment configuration information acquired from the fragment data and metadata stream separator 40 includes a reference to a metadata stream, the metadata concatenation unit 34c repeats the same processing recursively.

As described above, the present invention has the following effects:

(a) The transmitting side can transmit structured data in a plurality of fragment data pieces such that the structured data can be re-concatenated. The receiving side can determine the time at which to concatenate the fragment data and, at the same time, receive the structured data efficiently.
(b) Position information that is included in fragment configuration information, which is used to concatenate fragment data, and that indicates a position at which fragment data is to be connected is composed of information specifying a node in structured data to be generated and information specifying a position relative to that node at which the corresponding fragment data is to be connected. This makes it possible to correctly specify the positions necessary to concatenate structured data.
(c) When reference information that is included in fragment configuration information, which is used to concatenate fragment data, and that specifies fragment data has information on the contents of referenced fragment data, the receiving side can selectively receive and concatenate fragment data. This makes it possible to receive structured data efficiently.
(d) When reference information, which is included in fragment configuration information for concatenating fragment data and which specifies fragment data, has information on the name of the highest node of referenced fragment data, the receiving side can process other fragment configuration information appropriately even if the referenced data is not concatenated in the structured data and position information included in the other fragment configuration information specifies the position corresponding to the node of the referenced fragment data.

It should be understood that many modifications and adaptations of the invention will become apparent to those skilled in the art and it is intended to encompass such obvious modifications and changes in the scope of the claims appended hereto.

1.-28. (canceled)

29. A structured data receiving method of receiving a plurality of fragment data constituting a structured data having a tree structure described in an extensible markup language and a plurality of fragment data configuration information, created one for each fragment data, to concatenate said plurality of fragment data in a receiving side to generate the structured data stored,
each piece of fragment data configuration information including reference information having location information on a location of corresponding fragment data and position information on a connection position of the corresponding fragment data in the structured data,
said structured data receiving method comprising the step of:
specifying the location of the corresponding fragment data based on the reference information included in each piece of fragment data configuration information;
receiving fragment data from the specified location; and
concatenating the received fragment data to generate the structured data, based on the position information included in each piece of fragment data configuration information.

30. A structured data receiving method of receiving a plurality of fragment data constituting a structured data having a tree structure described in an extensible markup language and a plurality of fragment data configuration information, created one for each fragment data, to concatenate said plurality of fragment data in a receiving side to generate the structured data stored,
each piece of fragment data configuration information including reference information and position information on a connection position of the corresponding fragment data in the structured data, the reference information having location information on a location of corresponding fragment data and information on a name of a highest node of the corresponding fragment data,
said structured data receiving method comprising the step of:
specifying the location of the corresponding fragment data based on the location information included in the reference information included in each piece of fragment data configuration information;
receiving fragment data from the specified location;
processing said position information included in each piece of fragment data configuration information according to the information on the name of the highest node included in the reference information included in each piece of fragment data configuration information; and
concatenating the received fragment data to generate the structured data, based on the processed position information.

31. A structured data receiving method of receiving a plurality of fragment data constituting a structured data having a tree structure described in an extensible markup language and a plurality of fragment data configuration information, created one for each fragment data, to concatenate said plurality of fragment data in a receiving side to generate the structured data stored,
each piece of fragment data configuration information including reference information and position information on a connection position of the corresponding fragment data in the structured data, the reference information having location information on a location of corresponding fragment data and information on a content of the corresponding fragment data,
said structured data receiving method comprising the step of:
specifying the location of the corresponding fragment data based on the location information included in the reference information included in each piece of fragment data configuration information;
receiving from the specified location, fragment data determined to be concatenated based on the information on the content included in the reference information included in each piece of fragment data configuration information; and
concatenating the received fragment data to generate the structured data, based on the position information included in each piece of fragment data configuration information.

32. A structured data receiving method of receiving a plurality of fragment data constituting a structured data having a tree structure described in an extensible markup language and a plurality of fragment data configuration information, created one for each fragment data, to concatenate said plurality of fragment data in a receiving side to generate the structured data stored,
each piece of fragment data configuration information including reference information and position information on a connection position of the corresponding fragment data in the structured data, the reference information having location information on a location of corresponding fragment data, information on a name of a highest node of the corresponding fragment data, and information on a content of the corresponding fragment data,
said structured data receiving method comprising the step of:
specifying the location of the corresponding fragment data based on the location information included in the reference information included in each piece of fragment data configuration information;
receiving from the specified location, fragment data determined to be concatenated based on the information on the content included in the reference information included in each piece of fragment data configuration information;
processing the position information included in each piece of fragment data configuration information according to the information on the name of the highest node included in the reference information included in each piece of fragment data configuration information;
concatenating the received fragment data to generate the structured data, based on the processed position information.
